(19) United States
(12) Patent Application Publication
(10) Pub. No.: US 2025/0292271 A1
(43) Pub. Date: Sep. 18, 2025

(54) Systems and Methods for Data Sourcing, Integration, Distribution, and Forecasting for Enterprises

(71) Applicant: Second Harvest Food Bank of Northwest NC, Winston-Salem, NC (US)

(72) Inventor: Matthew Darrell NOOE, Winston-Salem, NC (US)

(21) Appl. No.: 19/080,591

(22) Filed: Mar. 14, 2025

Related U.S. Application Data
(60) Provisional application No. 63/565,715, filed on Mar. 15, 2024.

(51) Int. Cl. G06Q 30/0202; G06Q 30/015

(52) U.S. Cl. CPC G06Q 30/0202; G06Q 30/015

(57) ABSTRACT

Computer-implemented methods and platforms for data sourcing, integration, distribution, and forecasting for enterprises are provided. The methods and systems provided herein uses cloud computing infrastructure, to collect data from a plurality of systems to generate an indexed data store and to forecast a resource availability based on data in the indexed data store. The methods and systems provided herein can utilize advance artificial intelligence (AI) and machine learning (ML) techniques, coupled with robust data warehousing capabilities.

### CROSS REFERENCE TO RELATED APPLICATIONS

This application claims priority to U.S. Provisional Application No. 63/565,715 filed on Mar. 15, 2024, the content of which is incorporated herein by reference in its entirety.

### FIELD OF DISCLOSURE

This disclosure relates generally to a platform for data sourcing, integration, distribution, and forecasting.

### BACKGROUND

Enterprises such as non-profit entities and food banks face challenge of effectively managing finite resources and providing efficient, fair, and straightforward collaborations with partners. Due to the lack of comprehensive specialized software for the enterprise, many of the critical operational software platforms remain isolated and lack seamless communication with each other. Data has to be extracted from various systems, manually processed, and combined with other data to generate analytical dashboards or arrive at basic figures. This can be a laborious and time consuming process. It can take several days to determine the most basic metric depending on the complexity and the number of team members involved.

### SUMMARY

The disclosure describes a platform for data sourcing, integration, distribution, and forecasting for enterprises. The platform provided herein brings together over 70 distinct cloud-based technologies, unifying all data from the enterprises, irrespective of system type or software, and making it readily accessible to leaders and team members. The platform provides a comprehensive solution to issues facing enterprises, such as food banks. The platform utilizes advance artificial intelligence (AI) and machine learning (ML) techniques, coupled with robust data warehousing capabilities. For example, the platform can provide enterprises (such as food banks) with accessible and actionable data, for example to inform and elevate their food assistance programs.

### BRIEF DESCRIPTION OF THE DRAWINGS

FIG. 1 depicts a computer-implemented environment according to embodiments of the present disclosure.

FIG. 2A depicts a system that includes a standalone computer architecture according to embodiments of the present disclosure.

FIG. 2B depicts a system that includes a client server architecture according to embodiments of the present disclosure.

FIG. 2C depicts a block diagram of exemplary hardware for a standalone computer architecture according to embodiments of the present disclosure.

FIG. 3 depicts a flowchart of the data processing of the cloud computing infrastructure according to embodiments of the present disclosure.

FIG. 4A depicts example internal data sources according to embodiments of the present disclosure.

FIG. 4B depicts the data acquisition tier, the data transformation and storage tier, the data consumption tier, and the integration of predictive analysis and AI of the cloud-based platform according to embodiments of the present disclosure.

FIG. 5 depicts a diagram of AI virtual assistant platform according to embodiments of the present disclosure.

FIG. 6 depicts a diagram of AI chatbot and answers using generative AI foundation models according to embodiments of the present disclosure.

FIG. 7 depicts a diagram of AI chatbot and answers using generative AI foundation models according to embodiments of the present disclosure,

FIG. 8 depicts a diagram of donor personalized engagement with data intelligence on cloud-based platform according to embodiments of the present disclosure.

FIG. 9 depicts user and AI chatbot interaction on the user interface according to embodiments of the present disclosure.

FIG. 10 depicts user and AI chatbot interaction on the user interface according to embodiments of the present disclosure.

FIG. 11 depicts user and AI chatbot interaction on the user interface according to embodiments of the present disclosure.

FIG. 12 depicts user and AI chatbot interaction on the user interface according to embodiments of the present disclosure.

### DETAILED DESCRIPTION

In various embodiments, the platform employs a cloud computing infrastructure to establish connections with diverse data sources and systems, enabling the extraction of comprehensive insights from throughout an organization.

The platform provided herein employs a cloud computing infrastructure (such as web services) to establish connections with diverse data sources and systems, enabling the extraction of comprehensive insights from throughout an organization.

The “bring-your-own-data” architecture enables the platform to interface with various systems as required, thereby eliminating any constraints related to specific software requirements. The adaptable, software-agnostic design operates on an extensible data ingestion framework that accommodates API, file, and database integration methods. The platform seamlessly integrates with diverse data sources regardless of the software applications used to manage them, ensuring compatibility and accessibility for a variety of organizations.

The platform will extract data from internal sources such as the enterprise resource planning (ERP) system, accounts payable (A/P) & credit management, human capital management system (HCMS), case management, donor and volunteer customer relationship management (CRM) system, and hospitality point-of-sale (POS), as well as data extrapolated from parent organizations. This encompasses the annual report from relevant organizations, such as a vital repository of information (such as on food insecurity trends across the United States population). The data from these sources will be ingested into a cloud-based system, specifically leveraging an amorphic cloud. Subsequently, a self-service cloud platform will enable users to query these sources in real time.

Users, including staff, partners, volunteers, donors, and clients, will undergo initial authentication and authorization processes using cloud-based identity management and security services. Upon approval, they will gain access to an array of services, offering transformative data and analytics, as well as personalized experiences tailored to their specific level of clearance.

### A. Overview of Systems and Methods of the Present Disclosure

Computer-implemented methods and systems provided herein can include collecting first data from a first data source using a first protocol; collecting second data from a second data source using a second protocol different from the first protocol; generating an indexed data store comprising at least a portion of the first data and at least a portion of the second data; and forecasting a resource availability based on data in the indexed data store. The first data source may comprise at least one of an enterprise resource planning (ERP) system, an accounts payable and credit management system, a human capital management system, a case management system, a customer relationship management (CRM) system, or a point-of-sale system. The second data source may be different from the first data source and the second data source may comprise at least one of the enterprise resource planning (ERP) system, the accounts payable and credit management system, the human capital management system, the case management system, the customer relationship management (CRM) system, or the point-of-sale system.

Collecting first and second data (data acquisition) may be conducted in accordance with a database ingestion pattern, a flat file ingestion pattern, an application programming interfaces/software as a service (API/SaaS) ingestion pattern, or a data exchange ingestion pattern.

The resource availability may be forecasted using an artificial intelligence (AI) model. The method may further include forecasting a personalized resource availability and providing the personalized forecasted resource availability to a user via an AI interactive platform. Providing the personalized forecasted resource availability to the user may include exporting historical user interaction data from an analytics platform to a data store; interacting with the user while tracking user interactions via a tag; submitting the user interaction event to a cloud computing infrastructure; and providing the personalized resource availability to the user. The user may interact with the platform via voice or chat.

The methods and platforms provided herein may be used by any enterprises for data sourcing, integration, distribution, and forecasting. For example, the methods and platforms provided herein can be used by a food bank for forecasting the resource availability may include identifying available pantries as food sources in response to food demand. Forecasting the personalized resource availability may include conducting user location-based search, conducting resource mapping, using search filters, conducting equitable resource mapping, and providing recommendations and suggestions, and user reviews and ratings, and information regarding forecasted resource availability.

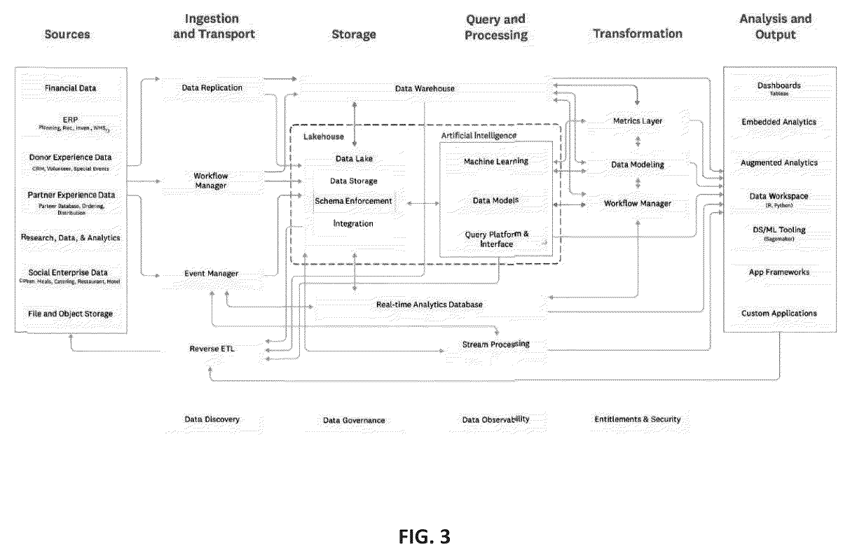

As shown in FIG. 3, the methods and systems can identify data sources (e.g., financial data, enterprise resource planning (planning, recommendation, inventory, warehouse management system), donor experience data (e.g., customer relationship management, volunteer, special events), partner experience data (partner database, ordering, distribution), research, data, analytics, social enterprise data (e.g., communication, meals, catering, restaurant, hotel), and file and object storage), collect data from the sources (e.g., data replication, workflow manager, event manager), store data (e.g., data warehouse, data lake (e.g., data storage, schema enforcement, integration), query and process AI (e.g., machine learning, data models, query platform and interface, real-time analytics database, stream processing), transform the collected data (e.g., metrics layer, data modeling, workflow manager), analyze (e.g., forecast the resource availability, e.g., dashboards, embedded analytics, augmented analytics, data workspace (e.g., Phyton), DS/ML tooling (e.g., end-to-end ML service), application frameworks, custom applications), and output the analysis and forecast.

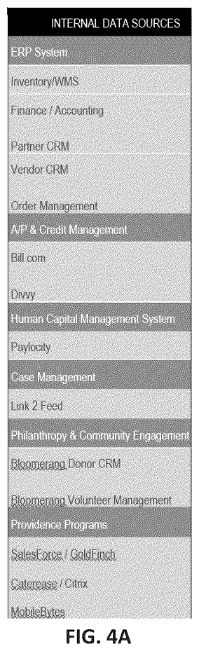

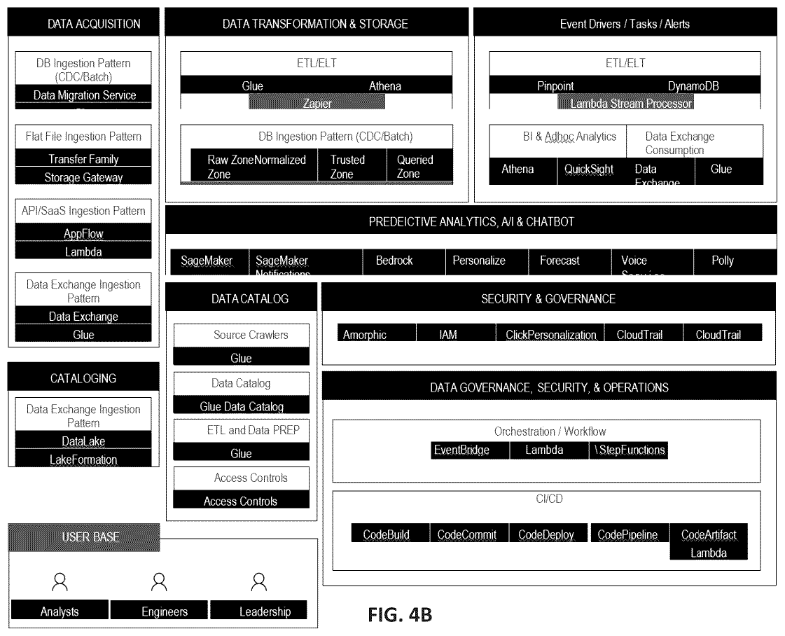

As shown in FIGS. 4A and 4B, data acquisition tier offers multiple patterns for ingesting data from diverse sources:
The database migration service database (DMS DB) ingestion pattern facilitates both Near-Time (NRT) ingestion using Change Data Capture (CDC) and batch-based data ingestion. DMS is a one-stop data management platform that allows you to manage data throughout its lifecycle. DMS can be used to manage global data assets, govern data, design and develop databases, integrate data, develop data, and consume data.
The integration service API ingestion pattern enables data export from SaaS vendors predominantly utilizing the representational state transfer (REST) API mechanism.
Data Exchange allows subscription to data published on the exchange for data ingestion.
The secure file transfer service Flat file ingestion pattern facilitates both secure shell (SSH) File Transfer Protocol (SFTP)/secure file transfer protocol (FTPS)-based and network file system (NFS)/server message block (SMB)-based file ingestion mechanisms,
The data transformation and storage tier facilitates storage and normalization/standardization of data by integrating different integration services and cloud computing infrastructure or a computer service for running code without managing servers.
The data integration, e.g., extract, transform, and load (ETL)/extract, load, transform (ELT) tier allows cost-effective data standardization and normalization utilizing serverless frameworks,
Storage is categorized into Raw zone, Normalized zone, Trusted zone, and Derived zone.
The serverless data integration service Catalog automatically catalogs all data, eliminating the need for manual crawler setup.

The data consumption tier facilitates the implementation of consumption patterns for downstream embedded and ad-hoc analytics.
cloud-based business intelligence service facilitates embedded analytics and forthcoming Generative AI capabilities through dashboarding and reporting, while an interactive query service enables serverless ad-hoc querying via SQL.
Redshift supports curated data marts designed for Line of Business (LOB) purposes to meet SLA-sensitive reporting needs.

The integration of Predictive Analytics and AI aims to facilitate AI-based food assistance, equitable resource matching, and forecasting.
End-to-end ML service and a service to build high-performing foundation models through a unified API are utilized for pre-trained foundational models and to address the ML operational requirements for training and deploying generative AI capabilities.
Personalization and forecasting services are leveraged to provide personalized user recommendations and to forecast inventory-related needs.
The service to convert text to audio and the service for building conversational interfaces for applications using voice and text are employed for special needs-assisted virtual assistance.
The Amorphic Data Governance and Security tier is instrumental in ensuring secure data access, auditing, and compliance enforcement.
The Amorphic Data Catalog is utilized as a centralized source of truth about the contents of the data lake.
Amorphic Workflow and Orchestration services, such as a serverless service that uses events to connect application components together, and cloud computing infrastructure Step Functions, are deployed to simplify ETL workflow management involving a diverse set of technologies.
Security measures for data at rest and in transit, role-based access control to data (cloud computing infrastructure IAM), and audit logging (cloud computing infrastructure CloudTrail) are implemented to bolster data security and governance.

### B. Cloud Computing Infrastructure Tools and Services Utilized in the Creation of AI Platform

### Secure File Transfer Service

The secure file transfer service simplifies migration of file-transfer-based workflows, such as cloud computing infrastructure Transfer for Secure File Transfer Protocol (SFTP), cloud computing infrastructure Transfer for File Transfer Protocol over SSL (FTPS), and cloud computing infrastructure Transfer for File Transfer Protocol (FTP) to cloud computing infrastructure. This will enable ingestion of flat files form emails and SFTP serves to cloud computing infrastructure and AI platform applications.

### Hybrid Cloud Storage Service

The hybrid cloud storage service gives on-premises access to virtually unlimited cloud storage.

### Cloud Computing Infrastructure Data Migration Services (DMS)

Cloud computing infrastructure DMS will migrate data—to and from—commercial and open source databases that contain data powering AI platform applications. Cloud computing infrastructure DMS DB ingestion pattern will enable both Near Real-Time (NRT) via Change Data Capture (CDC) and batch-based data ingestion across data source systems that will power AI platform.

### Integration Service

integration service will enable API ingestion pattern enables data export from SaaS vendor data sources primarily leveraging REST API mechanism.

### Cloud Computing Infrastructure Data Exchange

Cloud computing infrastructure Data Exchange will provide the ability to enhance existing data repository and ingest third party data sources published to the exchange.

### Serverless Data Integration Service & Serverless Compute Service

A serverless data integration service and serverless compute service will be used to enable the normalization and standardization of data and power the data transformation needs across multiple data formats enabling cost-effective data standardization using serverless framework.

### Cloud-Based Business Intelligence Service

Cloud-based business intelligence (BI) service will enable embedded analytics and Generative BI capabilities via dashboarding & reporting for internal stakeholders and executives. This will be used to power executive dashboards which will offer a comprehensive overview of essential information and key metrics, tailored specifically for executives. IT will also be used for sample operations KPI and dashboards serving as a visual representation of the key performance indicators, allowing to monitor and optimize operational efficiency.

### Interactive Query Service

An interactive query service will enable serverless ad hoc query capabilities via SQL on AI platform data sources

### End-to-End ML Service and Foundation Model Building Service

Cloud computing infrastructure ML and AI based predictive analytics services will be used to enable AI based food assistance and power generational BI and querying capabilities for internal stakeholders-front end staff experience and key stakeholders' dashboards.

### Personalize and Forecast

Personalize and Forecast will be used to powered personalized user recommendations and forecasting of inventory related needs. It will also utilize cloud computing infrastructure DynamoDB and API Gateway to power a web-based system to allow user traceability and personalized interaction history,

### Text to Audio Conversion Service and Conversational Chatbot Building Service

The service to convert text to audio and the service for building conversational interfaces for applications using voice and text will provide for special needs assisted virtual assistance that will enable an intelligent virtual assistant-streamlining their workflow, enhancing productivity for staff and providing personalized support and guidance to clients.

### Cloud Computing Infrastructure Identity and Access Management and User Activity and API Usage Tracking Service

Cloud computing infrastructure identity and access management (IAM) and a user activity and API usage tracking and monitoring service will enable security of data at rest and in transit; Role-based access control to data (cloud computing infrastructure IAM); Audit logging by a service that logs, continuously monitors, and retains account activity related to actions across the cloud computing infrastructure. Data Governance and Security tier enables secure access of data, auditing, and compliance enforcement.

### C. AI Platform Virtual Assistant-Equitable Resource Matching and Eligibility Assessment

To enable AI platform virtual assistant for Near Real-Time Personalized Recommendations on cloud computing infrastructure, a service to convert text to audio and a service for building conversational interfaces for applications using voice and text used for special needs virtual assistance. This will be using a web-based system to allow user traceability and personalized interaction history.

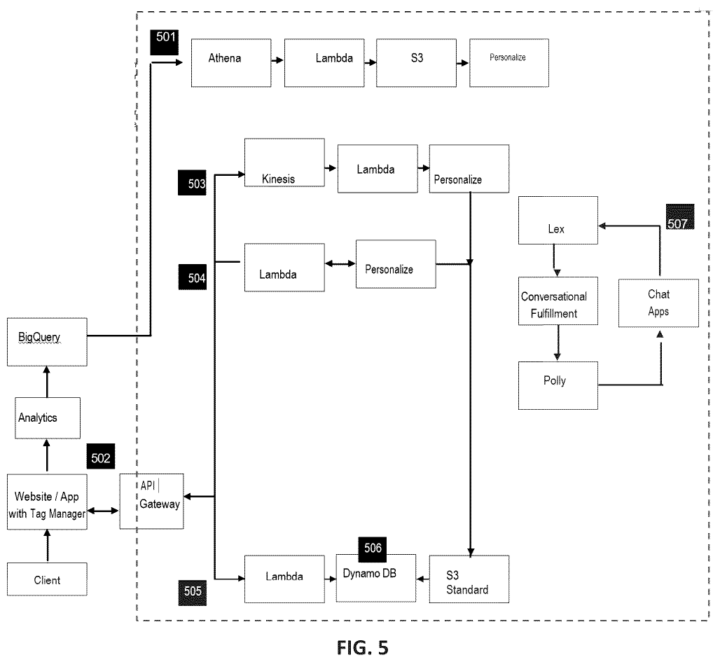

FIG. 5 depicts an example process. In step 501, an interactive query service queries and exports historical user interaction data from the Analytics platform to Simple Storage Service (S3) using Big Query. This data is used to train the Personalize user recommendation model.

In step 502, the user interacts with a website or a mobile app that uses tags to track user interactions.

In step 503, a tag submits the user interaction event to API Gateway. The user event record is sent to Kinesis.

In step 504, a computer service for running code without managing servers reads the records from the Kinesis stream and submits it to Personalize.

In step 505, a tag gets recommendations for the user. Personalize recommends items using the Recommended for You Recipe.

In step 506, user traceability is enabled by storing personalized user interaction history in DynamoDB directly from Google interactions as well as Personalize recommendations.

In step 507, time-based event triggers serverless compute service, which stars a batch inference to get starts an Personalize batch inference to get similar items. Inference results are stored in S3, and serverless compute service writes them to DynamoDB for use in the Advanced Composite Recipe. Chat and voice applications integrate with the service for building conversational interfaces for applications using voice and text to power conversational interfaces. The chatbot building service calls serverless compute service function to retrieve personalized recommendations for users and converts to audio to assist individuals with visual or cognitive challenges.

### D. AI Platform Chatbot & Answer Using Generative AI Foundation Models

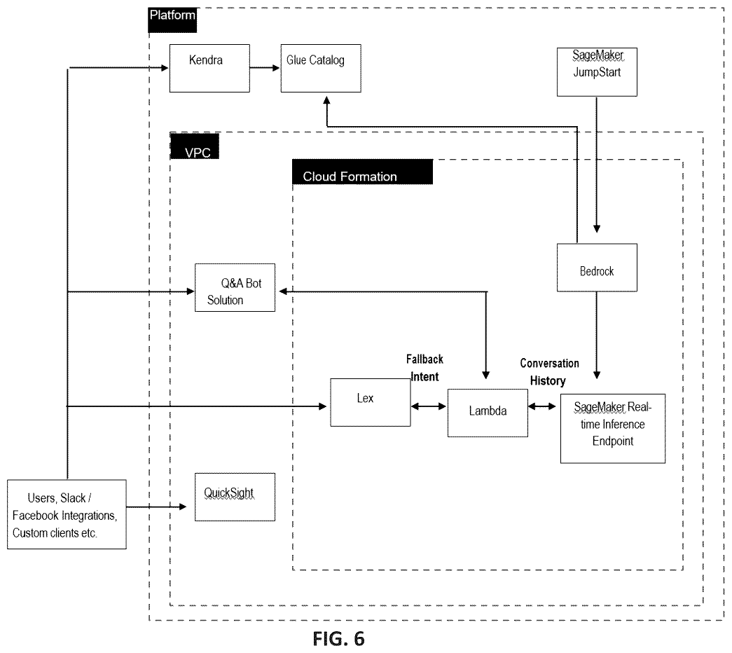

The architecture, for example as diagramed in FIG. 6 will enable self-service virtual assistants powered by Q and NLP services of a service to build high-performing foundation models through a unified API on AI Powered Data Catalog to provide support to internal stakeholders, as well as automate food support programs for internal stakeholders and partners, using self-service dashboards and generative BI capabilities in cloud-based business intelligence service. Users may interact with platform by social media or app. Platform may house ML-powered enterprise search and information retrieval service, serverless data integration service catalog, end-to-end ML service, and an end-to-end ML service that provides access to pre-trained models and algorithms, and VPC (e.g., AL-powered chat bot solution, cloud-based business intelligence service), and cloud formation (e.g., service to build high-performing foundation models through a unified API, service for building conversational interfaces for applications using voice and text, serverless compute service, end-to-end ML service real-time inference endpoint).

The solution integrates a chatbot with a popular open-source LLM from end-to-end ML service that provides access to pre-trained models and algorithms, accessible through an end-to-end ML service endpoint. A framework that simplifies LLM-powered applications can also be used. A generative AI-powered, multi-channel conversational chatbot can be used to provide a user interface for the chatbot provided herein.

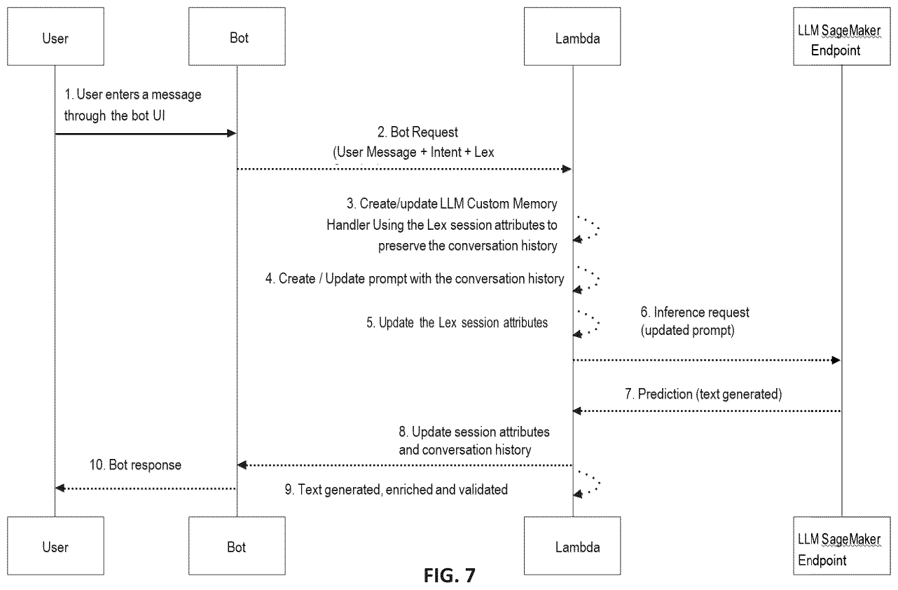

As shown in FIG. 7, an end-to-end ML service that provides access to pre-trained models and algorithms offers pre-trained open-source models for various problem types. This enables the platform to begin machine learning (ML) quickly. It includes the FLAN-T5-XL model, an LLM deployed into a deep learning container. It performs well on various natural language processing (NLP) tasks, including text generation.

An end-to-end ML service real-time inference endpoint enables fast, scalable deployment of ML models for predicting events. With the ability to integrate with serverless compute service functions, the endpoint allows for building custom applications.

The a computer service for running code without managing servers function uses the requests from the chatbot or the generative AI-powered, multi-channel conversational chatbot to prepare the payload to invoke the end-to-end ML service endpoint using a framework that lets developers create applications powered by LLMs.

The chatbot has the built-in Fallback Intent type. It is triggered when a user's input doesn't match any intents in the bot.

The generative AI-powered, multi-channel conversational chatbot is an open-source cloud computing infrastructure solution to provide a user interface to a chatbot. We configured it with a serverless compute service hook function for a Custom No Matches item, and it triggers the serverless compute service function when generative AI-powered, multi-channel conversational chatbot can't find an answer.

As depicted in FIG. 7, the user-platform interaction may proceed as follows:
1. A user enters a message through the bot user interface
2. The bot sends a request (e.g., user message, intent, and a chatbot building service) to serverless compute service
3. Serverless compute service creates or updates LLM custom memory handler using the chatbot building service session attributes to preserve the conversation history
4. Serverless compute service creates or updates prompt with the conversation history.
5. Serverless compute service updates the chatbot building service session attributes
6. Upon prompt, serverless compute service makes inference request to LLM end-to-end ML service or Endpoint.
7. LLM end-to-end ML service or Endpoint generates prediction (e.g., in the form of text) and transmits to serverless compute service
8. serverless compute service updates session attributes and conversation history
9. serverless compute service generates enriched and validated text and send it to Bot
10. Bot responds to the user providing the text

### E. Donor Personalized Engagement on Cloud Computing Infrastructure

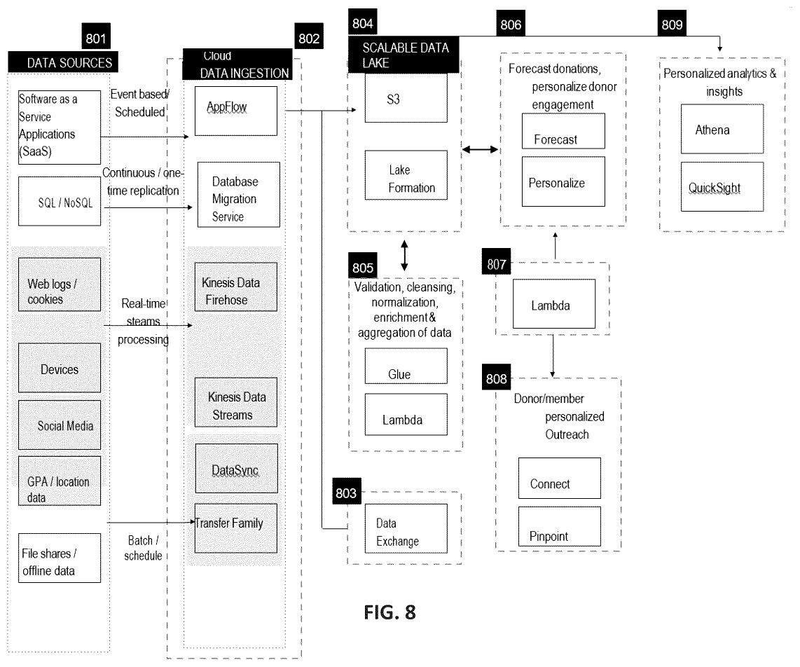

FIG. 8 depicts an example process of donor personalized engagement on the cloud computing infrastructure. The architecture exemplified in FIG. 8 can be used to power personalized experiences across the donor fundraising lifecycle by creating personalized recommendations based on a user's profile and behavior. It enables answering the following pieces: a) right amount to solicit, b) right frequency of engagement, and c) right channel of engagement. The architecture shows how non-profit customers can capture donor/member data from multiple sources, combine the data, leverage cloud computing infrastructure artificial intelligence/machine learning (AI/ML) services to perform data analysis, and generate a personalized outreach to donors/members.

In embodiments shown in FIG. 8, in step 801, the data is collected from multiple sources: Online (web activity coming from websites, social media platforms, emails, and online campaigns), and offline: (purchase history and subscriptions-primarily CRM and third-party data).

In step 802, based on the data source, cloud computing infrastructure DMS, cloud computing infrastructure data syncing and data streaming service, and integration service are used to ingest the data into a data lake in cloud computing infrastructure.

In step 803, cloud computing infrastructure Data Exchange could be used to augment the donor/member data with third-party data sets.

In step 804, cloud computing infrastructure Lake Formation is used to build the scalable data lake, and Simple Storage Service (S3) is used for its storage, cloud computing infrastructure Lake Formation is also used to enable unified governance to centrally manage security, access control (table, row and column level security), and audit trails. cloud computing infrastructure Lake Formation also enables automatic schema discovery and conversion to required format.

In step 805, cloud computing infrastructure serverless data integration service is used to extract, transform, catalog, and ingest data across multiple data stores. a computer service for running code without managing servers is used for enrichment and validation.

In step 806, cloud computing infrastructure ML services like Personalize and Forecast process the enriched data sets in S3. Personalize can be used to build an outreach channel personalization model. The output will contain data on recommendations for right donation amount, frequency, cause, and the outreach channel.

In step 807, a computer service for running code without managing servers is used to extract personalized data sets and forecasted donations from Personalize and Forecast.

In step 808, Connect is used to make personalized outbound calls to donors/members based on the generated data. Pinpoint is used to create campaigns and perform personalized outreaches via SMS and email to donors/members based on the data generated by Personalize and Forecast.

In step 809, cloud-based business intelligence service provides ML-powered business intelligence visualizations and dashboards that show key metrics such as donation impacts, fundraising goals achievement, and more. An interactive query service enables interactive querying, analyzing, and processing capabilities.

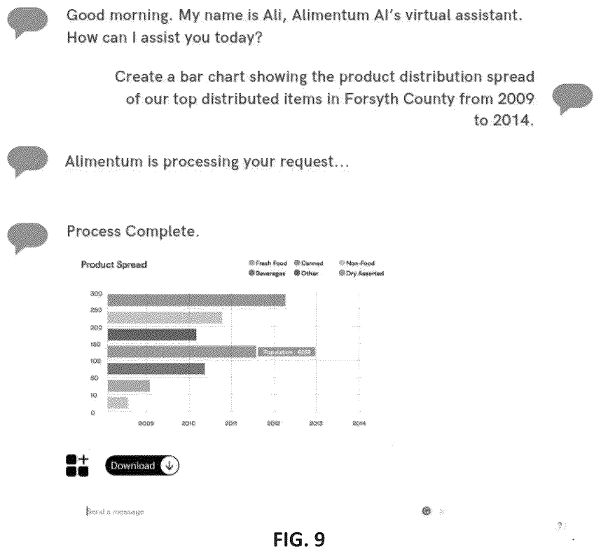

FIGS. 9-12 depict user and AI chatbot interaction in AI platform virtual assistant. In FIG. 9, ser requests data. The formatted data is then relayed back to the user in the form of an answer to their query. Users can opt to download the formatted data or save it as a widget to their KPI dashboard.

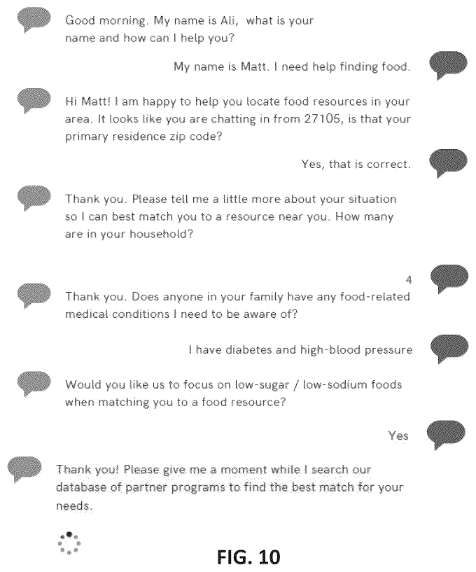

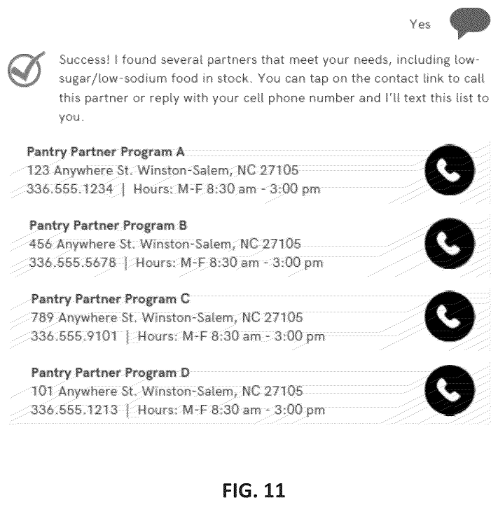

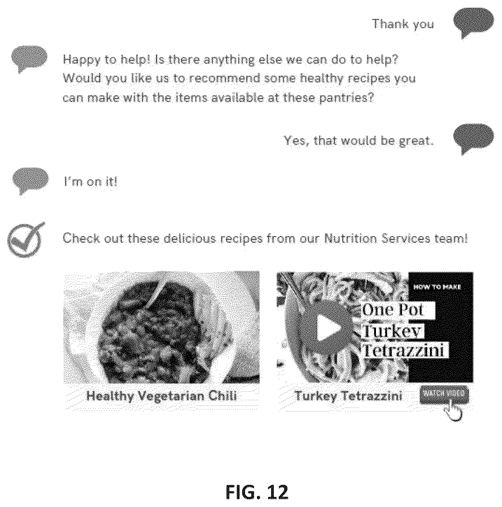

In FIG. 10, the user requests help finding food, and outlines the primary residence zip code, number of people in the household, and food-related medical conditions as prompted by the virtual assistance. In FIG. 11, the AI platform identifies pantries that may meet the user's needs. In FIG. 12, the AI platform asks if the user would like healthy recipes they can make with the items available at these pantries. The user says yes, and the AI platform provides recipes to the user.

### F. Features of Platform Services

The AI platform Virtual Assistance Chatbot aims to connect individuals in need with nearby resources (such as food resources) while prioritizing equitable resource matching to ensure that the right kinds of foods reach those who need them the most. The key features and functionalities of this virtual AI assistant can include the following:

Location-Based Search: The AI platform Virtual Assistant Chatbot utilizes the user's location data to provide a personalized experience. It allows users to search for food resources, such as food banks, community pantries, soup kitchens, and government assistance programs, based on their current location or a specified area.

Resource Mapping: The AI platform Virtual Assistant Chatbot presents a map interface that displays the locations of food resources in the user's vicinity. Users can interact with the map, zoom in/out, and explore different areas to identify nearby food assistance options.

Search Filters: To enhance the search experience, the AI Virtual Assistant Chatbot incorporates filters to refine the results based on specific criteria. Users can filter by resource type, hours of operation, specific food items, dietary restrictions, and other relevant factors.

Equitable Resource Matching: The virtual assistant chatbot goes beyond providing a general list of food resources. It employs algorithms and data analysis techniques to prioritize equitable resource matching. It considers factors such as proximity, availability of specific food items, nutritional value, and the needs of vulnerable populations to ensure fair distribution of resources.

Recommendations and Suggestions: Based on user preferences, dietary restrictions, or past search history, the virtual assistant chatbot can offer personalized recommendations and suggestions for nearby food resources. These recommendations may include food banks with specific services, community programs, or local initiatives that align with the user's needs.

User Reviews and Ratings: To help users make informed decisions, the AI Virtual Assistant Chatbot user interface (UI) incorporates user reviews and ratings for various food resources. Users can read feedback from others who have utilized the services, providing insights into the quality and effectiveness of the assistance provided.

Additional Information: The virtual assistant chatbot provides detailed information about each food resource, including address, contact information, operating hours, eligibility criteria, and any specific requirements for access. It may also present additional details such as transportation options, language support, and documentation needed to access the resources.

Multilingual Support: Recognizing the diverse user base, the AI Virtual Assistant Chatbot offers multilingual support, allowing users to interact and receive information in their preferred language. This ensures accessibility for individuals with different language backgrounds.

Real-Time Updates: The AI virtual assistant stays up-to-date with the latest information about food resources. It continuously monitors changes in operating hours, availability of specific food items, or new programs in the area. Users can rely on the assistant for accurate and timely information.

Seamless Communication: The AI virtual assistant facilitates communication channels between users and food resources. It may provide contact options such as phone numbers, email addresses, or chat interfaces to enable users to connect directly with the relevant organizations for further assistance or inquiries.

The AI platform virtual assistant for food assistance combines the power of technology and equitable resource matching to ensure that individuals in need receive the necessary support. By leveraging location-based search, personalized recommendations, and real-time updates, this assistant aims to bridge the gap between people seeking food assistance and the resources available in their communities.

AI platform Answers: a powerful virtual assistant that provides users with real-time access to query a vast database of information collected by the AI platform system. With the integration of generative AI and natural language processing, staff can now enjoy real-time access to robust analytics. AI platform Answers is designed to enhance productivity and streamline decision-making processes by providing accurate and efficient responses to user queries. Whether you need to retrieve specific data or analyze complex information, this AI assistant is here to assist you every step of the way

AI platform Open-Data Story Portal: aims to make complex data sets more accessible and engaging by presenting them in a narrative-driven manner. It combines the power of data visualization, storytelling, and interactive elements to create an immersive user experience.

Key features of the AI Open-Data Story Portal include:
Data Visualization: The portal utilizes interactive charts, graphs, maps, and infographics to visually represent complex data sets. This helps users understand trends, patterns, and relationships more intuitively.
Storytelling Framework: The interface employs a narrative structure to guide users through the data, presenting it in a coherent and engaging manner. This involves the use of compelling narratives, visuals, and multimedia elements to tell a data-driven story.
Interactivity and Exploration: Users can actively engage with the data by interacting with various elements on the interface. They may have the ability to filter, sort, and drill down into specific data points, enabling deeper exploration and analysis.
Dynamic Updates: The Open-Data Story Portal may provide real-time or regularly updated data, ensuring that users have access to the latest information. This feature allows users to stay informed about ongoing trends or changes in the data.
Accessibility and Responsiveness: The interface is designed to be accessible across different devices and screen sizes, ensuring a seamless user experience on desktops, tablets, and mobile devices. It may employ responsive design principles and adhere to accessibility guidelines.

By leveraging the power of storytelling and data visualization, the AI Open-Data Story Portal offers a unique way to communicate complex information effectively. It enables users to gain insights, explore trends, and make informed decisions based on the presented data.

As shown in FIGS. 9-12, the AI platform provided herein can engage in human-like, conversational interactions. The AI platform provided herein can connect individuals in need of food assistance with not only the nearest resource but also the most suitable resource, taking into account the specific requirements communicated by the individual seeking assistance. The AI platform provided herein can provide highly responsive and personalized assistance for individuals facing food insecurity. The AI platform also has the capacity to align individuals' requirements with accessible resources and services by examining real-time inventory levels, product distribution data, nutritional resource data, and other pertinent resources. This analysis also takes into consideration the specific needs and preferences of the individuals. For individuals with visual impairments, utilizes a customized instance of the service for building conversational interfaces for applications using voice and text, or the web service that powers the voice recognition AI interface, to hold voice conversations, answer questions, and provide information.

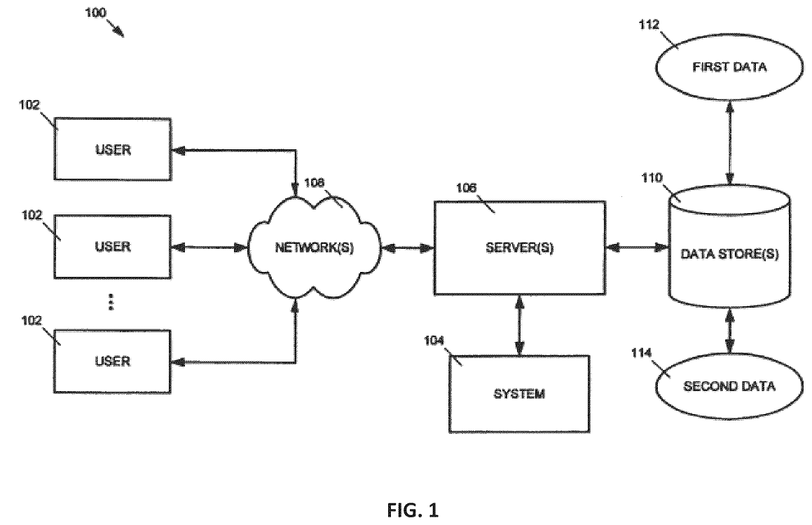

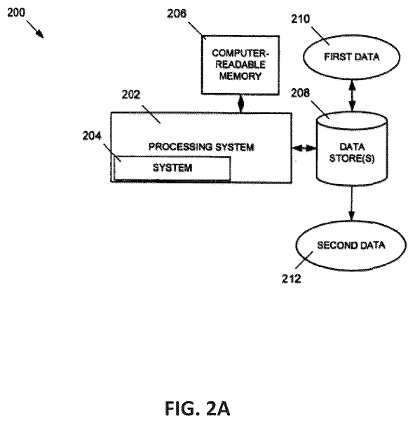

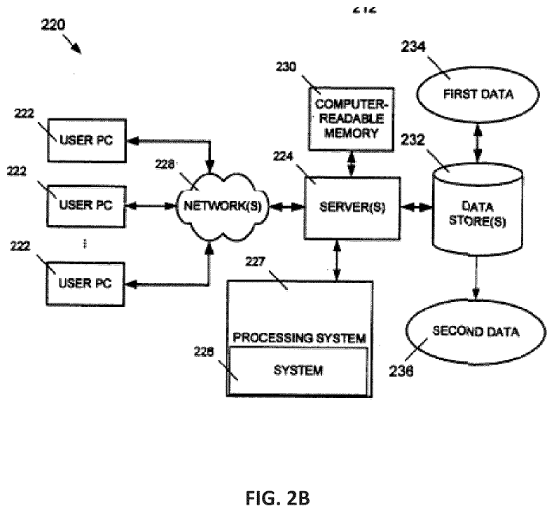

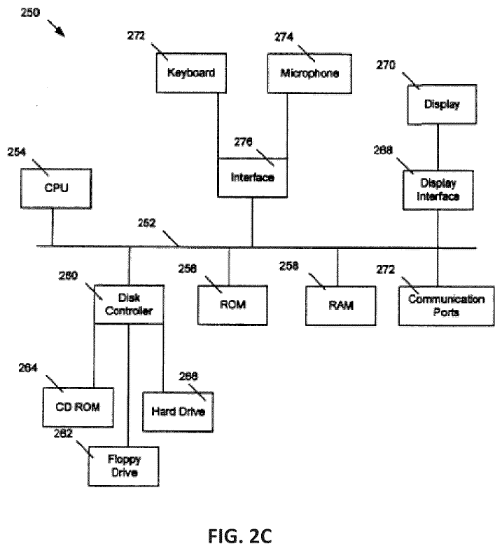

The methods and systems described herein may be implemented using any suitable processing system with any suitable combination of hardware, software and/or firmware, such as described below with reference to the non-limiting examples of FIGS. 1, 2A, 2B, and 2C.

FIG. 1 depicts at 100 a computer-implemented environment wherein users 102 can interact with a system 104 hosted on one or more servers 106 through a network 108. The system 104 contains software operations or routines. The users 102 can interact with the system 104 through a number of ways, such as over one or more networks 108. One or more servers 106 accessible through the network(s) 108 can host system 104. It should be understood that the system 104 could also be provided on a stand-alone computer for access by a user.

FIGS. 2A, 2B, and 2C depict example systems for use in implementing a system. For example, FIG. 2A depicts an exemplary system 200 that includes a standalone computer architecture where a processing system 202 (e.g., one or more computer processors) includes a system 204 being executed on it. The processing system 202 has access to a non-transitory computer-readable memory 206 in addition to one or more data stores 208. The one or more data stores 208 may contain first data 210 as well as second data 212.

FIG. 2B depicts a system 220 that includes a client server architecture. One or more user PCs 222 accesses one or more servers 224 running a system 226 on a processing system 227 via one or more networks 228. The one or more servers 224 may access a non-transitory computer readable memory 230 as well as one or more data stores 232. The one or more data stores 232 may contain first data 234 as well as second data 236.

FIG. 2C shows a block diagram of exemplary hardware for a standalone computer architecture 250, such as the architecture depicted in FIG. 2A, that may be used to contain and/or implement the program instructions of system embodiments of the present invention. A bus 252 may serve as the information highway interconnecting the other illustrated components of the hardware. A processing system 254 labeled CPU (central processing unit) (e.g., one or more computer processors), may perform calculations and logic operations required to execute a program. A non-transitory computer-readable storage medium, such as read only memory (ROM) 256 and random access memory (RAM) 258, may be in communication with the processing system 254 and may contain one or more programming instructions. Optionally, program instructions may be stored on a non-transitory computer-readable storage medium such as a magnetic disk, optical disk, recordable memory device, flash memory, or other physical storage medium. Computer instructions may also be communicated via a communications signal, or a modulated carrier wave, e.g., such that the instructions may then be stored on a non-transitory computer-readable storage medium.

A disk controller 260 interfaces one or more optional disk drives to the system bus 252. These disk drives may be external or internal floppy disk drives such as 262, external or internal CD-ROM, CD-R, CD-RW or DVD drives such as 264, or external or internal hard drives 266. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 260, the ROM 256 and/or the RAM 258. Preferably, processor 254 may access each component as required.

A display interface 268 may permit information from bus 256 to be displayed on display 270 in audio, graphic, or alphanumeric format. Communication with external devices may optionally occur using various communication ports 272.

In addition to the standard computer-type components, the hardware may also include data input devices, such as a keyboard 272, or other input device 274, such as a microphone, remote control, pointer, mouse, touchscreen and/or joystick.

This written description describes exemplary embodiments of the invention, but other variations fall within scope of the disclosure. For example, the systems and methods may include and utilize data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

The methods and systems described herein may be implemented on many different types of processing devices by program code comprising program instructions that are executable by the device processing system. The software program instructions may include source code, object code, machine code, or any other stored data that is operable to cause a processing system to perform the methods and operations described herein. Any suitable computer languages may be used such as C, C++, Java, etc., as will be appreciated by those skilled in the art. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other non-transitory computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

There are a number of embodiments described herein.

Example 1 is a computer-implemented method comprising collecting first data from a first data source using a first protocol; collecting second data from a second data source using a second protocol different from the first protocol; generating an indexed data store comprising at least a portion of the first data and at least a portion of the second data; and forecasting a resource availability based on data in the indexed data store.

Example 2 is the computer-implemented method of Example 1, wherein the first data source comprises at least one of an enterprise resource planning (ERP) system, an accounts payable and credit management system, a human capital management system, a case management system, a customer relationship management (CRM) system, or a point-of-sale system.

Example 3 is the computer-implemented method of Example 1, wherein the second data source is different from the first data source and the second data source comprises at least one of the enterprise resource planning (ERP) system, the accounts payable and credit management system, the human capital management system, the case management system, the customer relationship management (CRM) system, or the point-of-sale system.

Example 4 is the computer-implemented method of Example 1, wherein collecting the first and second data comprises a database ingestion pattern, a flat file ingestion pattern, an application programming interfaces/software as a service (API/SaaS) ingestion pattern, or a data exchange ingestion pattern.

Example 5 is the computer-implemented method of Example 1, wherein the resource availability is forecasted using an artificial intelligence (AI) model.

Example 6 is the computer-implemented method of Example 1, further comprising forecasting a personalized resource availability and providing the personalized forecasted resource availability to a user via an AI interactive platform.

Example 7 is the computer-implemented method of Example 6, wherein providing the personalized forecasted resource availability to the user comprises: exporting historical user interaction data from an analytics platform to a data store; interacting with the user while tracking user interactions via a tag; submitting the user interaction event to a cloud computing infrastructure; and providing the personalized resource availability to the user.

Example 8 is the computer-implemented of Example 7, wherein the user interacts with the platform via voice or chat.

Example 9 is the computer-implemented method of Example 1, wherein forecasting the resource availability comprises identifying available pantries as food sources in response to food demand.

Example 10 is the computer-implemented method of Example 6, wherein forecasting the personalized resource availability comprises conducting user location-based search, conducting resource mapping, using search filters, conducting equitable resource mapping, and providing recommendations and suggestions, and user reviews and ratings, and information regarding forecasted resource availability.

Example 11 is non-transitory machine-readable medium having executable instructions to cause one or more processing units to perform a method, the method comprising: collecting first data from a first data source using a first protocol; collecting second data from a second data source using a second protocol different from the first protocol; generating an indexed data store comprising at least a portion of the first data and at least a portion of the second data; and forecasting a resource availability based on data in the indexed data store.

Example 12 is the non-transitory machine-readable medium of Example 11, wherein the first data source comprises at least one of an enterprise resource planning (ERP) system, an accounts payable and credit management system, a human capital management system, a case management system, a customer relationship management (CRM) system, or a point-of-sale system.

Example 13 is the non-transitory machine-readable medium of Example 11, wherein the second data source is different from the first data source and the second data source comprises at least one of the enterprise resource planning (ERP) system, the accounts payable and credit management system, the human capital management system, the case management system, the customer relationship management (CRM) system, or the point-of-sale system.

Example 14 is the non-transitory machine-readable medium of Example 11, wherein collecting the first and second data comprises a database ingestion pattern, a flat file ingestion pattern, an application programming interfaces/software as a service (API/SaaS) ingestion pattern, or a data exchange ingestion pattern.

Example 15 is the non-transitory machine-readable medium of Example 11, wherein the resource availability is forecasted using an artificial intelligence (AI) model.

Example 16 is the non-transitory machine-readable medium of Example 11, further comprising forecasting a personalized resource availability and providing the personalized forecasted resource availability to a user via an AI interactive platform.

Example 17 is the non-transitory machine-readable medium of Example 16, wherein providing the personalized forecasted resource availability to the user comprises: exporting historical user interaction data from an analytics platform to a data store; interacting with the user while tracking user interactions via a tag; submitting the user interaction event to a cloud computing infrastructure; and providing the personalized resource availability to the user.

Example 18 is the computer-implemented of Example 17, wherein the user interacts with the platform via voice or chat.

Example 19 is the non-transitory machine-readable medium of Example 11, wherein forecasting the resource availability comprises identifying available pantries as food sources in response to food demand.

Example 20 is the non-transitory machine-readable medium of Example 16, wherein forecasting the personalized resource availability comprises conducting user location-based search, conducting resource mapping, using search filters, conducting equitable resource mapping, and providing recommendations and suggestions, and user reviews and ratings, and information regarding forecasted resource availability.

1. A computer-implemented method comprising:
collecting first data from a first data source using a first protocol;
collecting second data from a second data source using a second protocol different from the first protocol;
generating an indexed data store comprising at least a portion of the first data and at least a portion of the second data; and
forecasting a resource availability based on data in the indexed data store.

2. The computer-implemented method of claim 1, wherein the first data source comprises at least one of an enterprise resource planning (ERP) system, an accounts payable and credit management system, a human capital management system, a case management system, a customer relationship management (CRM) system, or a point-of-sale system.

3. The computer-implemented method of claim 1, wherein the second data source is different from the first data source and the second data source comprises at least one of the enterprise resource planning (ERP) system, the accounts payable and credit management system, the human capital management system, the case management system,
the customer relationship management (CRM) system, or the point-of-sale system.

4. The computer-implemented method of claim 1, wherein the collecting the first and second data comprises a database ingestion pattern, a flat file ingestion pattern, an application programming interfaces/software as a service (API/SaaS) ingestion pattern, or a data exchange ingestion pattern.

5. The computer-implemented method of claim 1, wherein the resource availability is forecasted using an artificial intelligence (AI) model.

6. The computer-implemented method of claim 1, further comprising forecasting a personalized resource availability and providing the personalized forecasted resource availability to a user via an AI interactive platform.

7. The computer-implemented method of claim 6, wherein providing the personalized forecasted resource availability to the user comprises:
exporting historical user interaction data from an analytics platform to a data store;
interacting with the user while tracking user interactions via a tag;
submitting the user interaction event to a cloud computing infrastructure; and
providing the personalized resource availability to the user.

8. The computer-implemented of claim 7, wherein the user interacts with the platform via voice or chat.

9. The computer-implemented method of claim 1, wherein forecasting the resource availability comprises identifying available pantries as food sources in response to food demand.

10. The computer-implemented method of claim 6, wherein forecasting the personalized resource availability comprises conducting user location-based search, conducting resource mapping, using search filters, conducting equitable resource mapping, and providing recommendations and suggestions, and user reviews and ratings, and information regarding forecasted resource avaiblability.

11. A non-transitory machine-readable medium having executable instructions to cause one or more processing units to perform a method, the method comprising:
collecting first data from a first data source using a first protocol;
collecting second data from a second data source using a second protocol different from the first protocol;
generating an indexed data store comprising at least a portion of the first data and at least a portion of the second data; and
forecasting a resource availability based on data in the indexed data store.

12. The non-transitory machine-readable medium of claim 11, wherein the first data source comprises at least one of an enterprise resource planning (ERP) system, an accounts payable and credit management system, a human capital management system, a case management system, a customer relationship management (CRM) system, or a point-of-sale system.

13. The non-transitory machine-readable medium of claim 11, wherein the second data source is different from the first data source and the second data source comprises at least one of the enterprise resource planning (ERP) system, the accounts payable and credit management system, the human capital management system, the case management system,
the customer relationship management (CRM) system, or the point-of-sale system.

14. The non-transitory machine-readable medium of claim 11, wherein collecting the first and second data comprises a database ingestion pattern, a flat file ingestion pattern, an application programming interfaces/software as a service (API/SaaS) ingestion pattern, or a data exchange ingestion pattern.

15. The non-transitory machine-readable medium of claim 11, wherein the resource availability is forecasted using an artificial intelligence (AI) model.

16. The non-transitory machine-readable medium of claim 11, further comprising forecasting a personalized resource availability and providing the personalized forecasted resource availability to a user via an AI interactive platform.

17. The non-transitory machine-readable medium of claim 16, wherein providing the personalized forecasted resource availability to the user comprises:
exporting historical user interaction data from an analytics platform to a data store;
interacting with the user while tracking user interactions via a tag;
submitting the user interaction event to a cloud computing infrastructure; and
providing the personalized resource availability to the user.

18. The computer-implemented of claim 17, wherein the user interacts with the platform via voice or chat.

19. The non-transitory machine-readable medium of claim 11, wherein forecasting the resource availability comprises identifying available pantries as food sources in response to food demand.

20. The non-transitory machine-readable medium of claim 16, wherein forecasting the personalized resource availability comprises conducting user location-based search, conducting resource mapping, using search filters, conducting equitable resource mapping, and providing recommendations and suggestions, and user reviews and ratings, and information regarding forecasted resource availability.
